(19) United States
(12) Patent Application Publication
(10) Pub. No.: US 2019/0124575 A1
(43) Pub. Date: Apr. 25, 2019

(54) METHOD TO IMPROVE ONE SUBSCRIPTION DATA THROUGHPUT AFTER TURN WAY ON DSDS PHONE

(71) Applicant: QUALCOMM INCORPORATED, San Diego, CA (US)

(72) Inventors: Xiaojian LONG, San Diego, CA (US); Xuepan Guan, Beijing (CN); Yong Xie, Beijing (CN); Ling Xie, Beijing (CN); Shiau-He Tsai, San Diego, CA (US); Zhang Zhou, San Diego, CA (US)

(21) Appl. No.: 16/093,960

(22) PCT Filed: May 26, 2016
(86) PCT No.: PCT/CN2016/083489

§ 371 Date: Oct. 15, 2018

(51) Int. Cl. H04W 36/14; H04W 8/18; H04W 76/38

(52) U.S. Cl. CPC H04W 36/14; H04W 76/38; H04W 8/183

(57) ABSTRACT

Embodiments described herein relate to managing communications for a first subscription and a second subscription of a wireless communication device, including, but not limited to, using a reduced re-order release timer having a reduced length in response to determining that a length of a tune-away interval exceeds a threshold. In some embodiments, a reduced status prohibit timer is initiated in response to determining that the length of the tune-away interval exceeds a threshold. In some embodiments, two or more status reports are transmitted during a same status prohibit timer in response to determining that transmission window occupancy exceeds a threshold.

### BACKGROUND

A wireless communication device, such as a mobile phone device or a smart phone, may include two or more Subscriber Identity Modules (SIMs). Each SIM may correspond to at least one subscription via a Radio Access Technology (RAT). Such a wireless communication device may be a multi-SIM wireless communication device. In a Multi-SIM-Multi-Active (MSMA) wireless communication device, all SIMs may be active at the same time. In a Multi-SIM-Multi-Standby (MSMS) wireless communication device, if any one SIM is active, then the rest of the SIM(s) may be in a standby mode. The RATs may include, but are not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network.

Two or more subscriptions in a MSMS wireless communication device may share a Radio Frequency (RF) resource for transmission and reception. During a tune-away, the RF resource may be tuned from a first subscription to a second subscription for second-subscription activities. Thus, first-subscription activities that overlap or collide in time with the tune-away may fail due to that the RF resource is not tuned into the first subscription. Such effects can be more pronounced when the tune-away interval is longer. However, a scheduling hole for a High-Speed Shared Control Channel (HS-SCCH) can be caused by reasons in addition to the tune-away itself.

For example, a re-ordering release timer in a Media Access Control (MAC) layer of the wireless communication device is started when a data packet (e.g., Protocol Data Unit (PDU)) having a sequence number (e.g., a Transmission Sequence Number (TSN)) greater than an expected sequence number is received. For instance, following a data packet with a sequence number k, a next data packet is expected to have a sequence number of k+1. If the next data packet has a sequence number of k+n where n>1, then the re-ordering release timer is started. The discontinuous sequence numbers may be caused by the tune-away (e.g., the data packets for the first subscription may not be received while the RF resource is tuned to the second subscription).

While the re-ordering release timer is running, the wireless communication device stands by for network retransmission (e.g., through Hybrid Automatic Repeat Request (HARD) retransmissions) of the missed data packets and cannot release received data packets (with the discontinuous sequence numbers) to a Radio Link Control (RLC) layer for processing unless the missing data packets have been recovered. The wireless communication device releases the received data packets (with the discontinuous sequence numbers) to the RLC layer for processing after the re-ordering release timer expires. The expiration of the re-ordering release timer indicates that the missed data packets are not recoverable. Therefore, a length of the re-ordering release timer enlarges the scheduling hole of the first subscription.

Another reason for the scheduling hole relates to a status report not being sent to the network associated with the first subscription in a timely manner due to a status prohibit timer. The status prohibit timer prevents the wireless communication device from sending consecutive status reports (e.g., Acknowledgement (ACK) or Negative Acknowledgement (NACK)). For instance, the status prohibit timer may be started or restarted in response to a status report being indicated by a lower layer. In Universal Terrestrial Radio Access Network (UTRAN), the status prohibit timer may be started or restarted in response to submitting a status report to the lower layer. A length of the status prohibit timer is indicated by upper layers. After the current status report is triggered and before the expiration of the status prohibit timer, sending additional status reports is prohibited. If an additional status report is triggered during the status prohibit timer, the transmission of the additional status report is delayed until the status prohibit timer expires.

An additional reason for the scheduling hole is the transmission window of the network RLC being full. The tune-away to the second subscription may cause a considerable number of data packets (e.g., RLC PDUs) of the first subscription to be lost if these data packets overlap or collide with the tune-away interval in time. Whereas the wireless communication device fails to transmit NACKs corresponding to the lost data packets to the network associated with the first subscription in time or the wireless communication device fails to transmit ACKs corresponding to retransmitted data packets that have been successfully received, the transmission window (TX_Win) of the network may be full.

### SUMMARY

Embodiments described herein are related to reducing scheduling holes of a first subscription of a Multi-SIM-Multi-Standby (MSMS) wireless communication device caused by tune-aways from the first subscription to a second subscription. Specifically, the embodiments are directed to shortening response time of the wireless communication device after the tune-aways. In some embodiments, a reduced re-ordering release timer having a reduced length may be initiated in response to determining that a length of a tune-away interval exceeds a threshold. In some embodiments, a reduced status prohibit timer is initiated in response to determining that the length of the tune-away interval exceeds a threshold. In some embodiments, a status report is transmitted irrespective of a previous status prohibit timer in response to determining that a transmission window occupancy exceeds a threshold.

[Complete when claims are finalized]

### BRIEF DESCRIPTION OF THE DRAWINGS

The accompanying drawings, which are incorporated herein and constitute part of this specification, illustrate exemplary embodiments of the disclosure, and together with the general description given above and the detailed description given below, serve to explain the features of the various embodiments.

FIG. 1 is a schematic diagram of a communication system in accordance with various embodiments.

FIG. 2 is a component block diagram of an example of a wireless communication device according to various embodiments.

FIG. 3 is a process flowchart diagram illustrating an example of a communication management method according to various embodiments.

FIG. 4A is a schematic diagram illustrating an example of a communication management method according to some embodiments.

FIG. 4B is a schematic diagram illustrating an example of a communication management method according to some embodiments.

FIG. 5 is a process flowchart diagram illustrating an example of a communication management method according to various embodiments.

FIG. 6 is a process flowchart diagram illustrating an example of a communication management method according to various embodiments.

FIG. 7A is a schematic diagram illustrating an example of a communication management method according to some embodiments.

FIG. 7B is a schematic diagram illustrating an example of a communication management method according to some embodiments.

FIG. 8 is a process flowchart diagram illustrating an example of a communication management method according to various embodiments.

FIG. 9 is a process flowchart diagram illustrating an example of a communication management method according to various embodiments.

FIG. 10A is a schematic diagram illustrating an example of a communication management method according to some embodiments.

FIG. 10B is a schematic diagram illustrating an example of a communication management method according to some embodiments.

FIG. 11 is a process flowchart diagram illustrating an example of a communication management method according to various embodiments.

FIG. 12 is a component block diagram of a wireless communication device suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

Some modern communication devices, referred to herein as a wireless communication device, User Equipment (UE), or Mobile Station (MS), may include any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such a wireless communication device may include at least one Subscriber Identity Module (SIM), a programmable processor, memory, and circuitry for connecting to two or more mobile communication networks.

A wireless communication device may include one or more SIMs that provide users of the wireless communication devices with access to one or multiple separate mobile communication networks. The mobile communication networks may be supported by Radio Access Technologies (RATs). The wireless communication device may be configured to connect to one or more base stations via one or more RATs. Examples of RATs may include, but not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network. Each RAT may be associated with a subscription or SIM.

A wireless communication device provided with a plurality of SIMs and connected to two or more subscriptions or networks with one subscription or network being active at a given time is a Multi-SIM-Multi-Standby (MSMS) communication device. In one example, the MSMS communication device may be a Dual-SIM-Dual-Standby (DSDS) communication device, which may include two SIMs that may both be active on standby, but one is deactivated when the other one is in use. In another example, the MSMS communication device may be a Triple-SIM-Triple-Standby (TSTS) communication device, which includes three SIMs that may all be active on standby, where two may be deactivated when the third one is in use. In other examples, the MSMS communication device may be other suitable multi-SIM communication devices, with, for example, four or more SIMs, such that when one is in use, the others may be deactivated.

On the other hand, a wireless communication device that includes a plurality of SIMs and connects to two or more subscriptions or networks with two or more subscriptions or networks being active at a given time may be a MSMA communication device. An example MSMA communication device may be a Dual-SIM-Dual-Active (DSDA) communication device, which may include two SIM. Both SIMs may remain active. In another example, the MSMA device may be a Triple-SIM-Triple-Active (TSTA) communication device, which may include three SIM. All three SIMs may remain active. In other examples, the MSMA communication device may be other suitable multi-SIM communication devices with four or more SIMs, all of which may be active.

Generally, embodiments described herein may be applicable to a MSMS wireless communication device having at least a first SIM and a second SIM. Illustrating with a non-limiting example, the first SIM may be associated with a first subscription via a first RAT, and the second SIM may be associated with a second subscription via a second RAT. The embodiments may also be applicable to a MSMA wireless communication device that halts first subscription communication activities due to blanking pattern, power back-off, interference, and/or the like when the second subscription receives pages or other types of communication.

As used herein, the terms “SIM,” “SIM card,” and “subscriber identification module” may be used interchangeably to refer to a memory that may be an integrated circuit or embedded into a removable card, and that stores an International Mobile Subscriber Identity (IMSI), related key, and/or other information used to identify and/or authenticate a wireless device on a network and enable communication services with the network. Because the information stored in a SIM may be the wireless device to establish a communication link for a particular communication service with a particular network, the term “SIM” may also be used herein as a shorthand reference to the communication service (e.g., the networks, the subscriptions, the services, and/or the like) associated with and enabled by the information (e.g., in the form of various parameters) stored in a particular SIM as the SIM and the communication network, as well as the services and RATs supported by that network, correlate to one another.

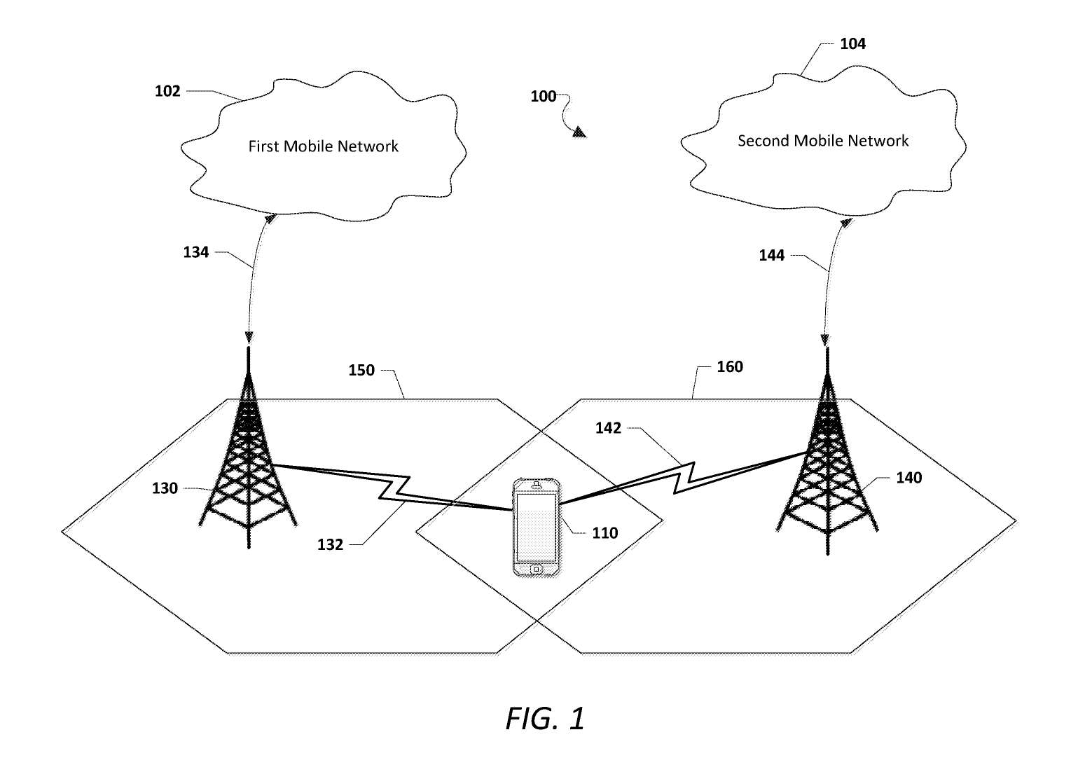

Various embodiments may be implemented within a communication system 100, an example of which is illustrated in FIG. 1. Referring to FIG. 1, a first mobile network 102 and a second mobile network 104 may each associate with a plurality of cellular base stations (e.g., a first base station 130 and a second base station 140, respectively). The first base station 130 may broadcast the first mobile network 102 in a first serving cell 150. The second base station 140 may broadcast the second mobile network 104 in a second serving cell 160. A wireless communication device 110 may be associated with (within effective boundaries of) both the first serving cell 150 and the second serving cell 160.

The wireless communication device 110 may be in communication with the first mobile network 102 through a first cellular connection 132 to the first base station 130. The first cellular connection 132 may correspond to the first RAT of the wireless communication device 110. The wireless communication device 110 may also be in communication with the second mobile network 104 through a second cellular connection 142 to the second base station 140. The second cellular connection 142 may correspond to the second RAT of the wireless communication device 110, as in a multi-SIM context. The first base station 130 may be in communication with the first mobile network 102 over a wired or wireless connection 134. The second base station 140 may be in communication with the second mobile network 104 over a wired or wireless connection 144.

The first cellular connection 132 and the second cellular connection 142 may be made through two-way wireless communication links. Each of the wireless communication links may be enable by any suitable protocol including, but not limited to, FDMA, TDMA, CDMA (e.g., EVDO), UMTS (e.g., WCDMA, LTE, HSDPA, or the like), GSM, 1×, GPRS, Wi-Fi, PCS, and/or another protocol used in a wireless communications network or a data communications network. By way of illustrating with a non-limiting example, the first cellular connection 132 may be an LTE connection. The second cellular connection 142 may be an LTE connection or any other suitable connection. Other RATs (such as, but not limited to, WCDMA, HSDPA, EVDO, and the like) may be implemented in a similar manner.

Each of the first base station 130 and the second base station 140 may include at least one antenna group or transmission station located in the same or different areas. The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some embodiments, the first base station 130 and the second base station 140 may be an access point, Node B, evolved Node B (eNodeB or eNB), base transceiver station (BTS), or the like.

In various embodiments, the wireless communication device 110 may be configured to access the first mobile network 102 and the second mobile network 104 by virtue of the multi-SIM and/or the multi-mode SIM configuration of the wireless communication device 110 (e.g., via the first cellular connection 132 and the second cellular connection 142). When a SIM corresponding to a RAT is inserted, the wireless communication device 110 may access the mobile communication network associated with that RAT based on the information stored on the SIM through registrations and call setups.

While the wireless communication device 110 is shown connected to the mobile networks 102 and 104 via two cellular connections, in other embodiments (not shown), the wireless communication device 110 may establish additional network connections using at least one additional RAT.

In some embodiments, the wireless communication device 110 may establish a wireless connection with a peripheral device (not shown) used in connection with the wireless communication device 110. For example, the wireless communication device 110 may communicate over a Bluetooth® link with a Bluetooth-enabled personal computing device (e.g., a “smart watch”). In some embodiments, the wireless communication device 110 may establish a wireless connection with a wireless access point (not shown), such as over a Wi-Fi connection. The wireless access point may be configured to connect to the Internet or another network over a wired connection.

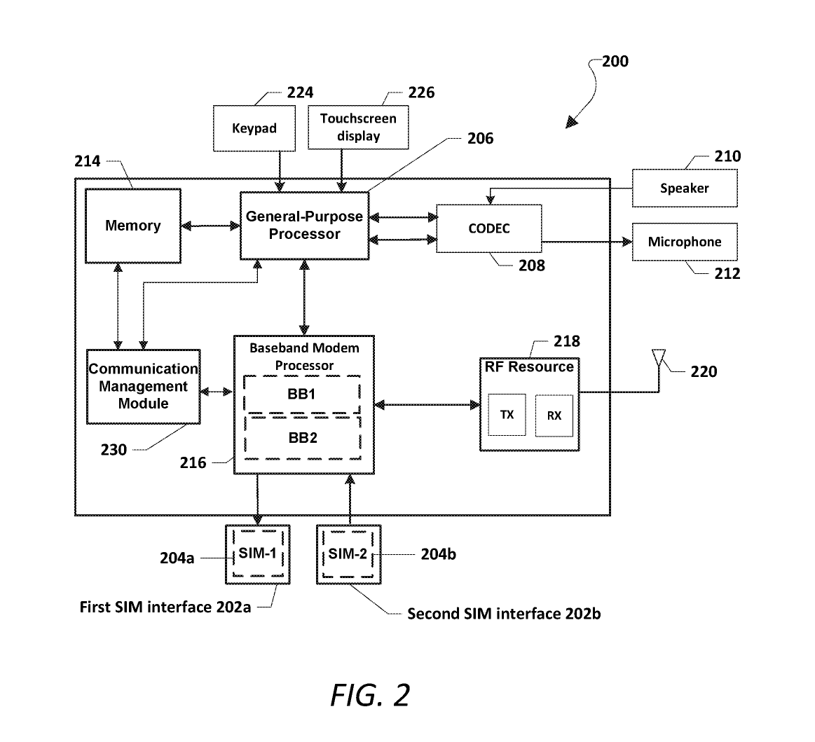

FIG. 2 is a functional block diagram of a wireless communication device 200 suitable for implementing various embodiments. According to various embodiments, the wireless communication device 200 may be the wireless communication device 110 as described with reference to FIG. 1. Referring to FIGS. 1-2, the wireless communication device 200 may include a first SIM interface 202a, which may receive a first identity module SIM-1 204a that is associated with the first mobile network 102. The wireless communication device 200 may also include a second SIM interface 202b, which may receive a second identity module SIM-2 204b that is associated with the second mobile network 104.

A SIM (e.g., SIM-1 204a, SIM-2 204b, and/or the like) in various embodiments may be a Universal Integrated Circuit Card (UICC) that is configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA Subscriber Identity Module (CSIM) on a card. A SIM card may have a Central Processing Unit (CPU), Read Only Memory (ROM), Random Access Memory (RAM), Electrically Erasable Programmable Read-Only Memory (EEPROM) and Input/Output (I/O) circuits. An Integrated Circuit Card Identity (ICCID) SIM serial number may be printed on the SIM card for identification. However, a SIM may be implemented within a portion of memory of the wireless communication device 200, and thus need not be a separate or removable circuit, chip, or card.

A SIM used in various embodiments may store user account information, an IMSI, a set of SIM Application Toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a Digital Signal Processor (DSP) and a microprocessor, a plurality of microprocessors, at least one microprocessor in conjunction with a DSP core, or any other such configuration).

The memory 214 may be a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but are not limited to, RAM, ROM, floppy disks, hard disks, dongles or other Recomp Sensor Board (RSB) connected memory devices, or the like. The memory 214 may store an Operating System (OS), user application software, and/or executable instructions. The memory 214 may also store application data, such as an array data structure.

The general-purpose processor 206 and the memory 214 may each be coupled to baseband modem processor 216. The SIMs (e.g., the SIM-1 204a, the SIM-2 204b, and/or the like) in the wireless communication device 200 may be associated with at least one baseband-RF resource chain. A baseband-RF resource chain may include the baseband modem processor 216, which may perform baseband/modem functions for communications on the SIMs. The baseband modem processor 216 may include one or more amplifiers and radios, referred to generally herein as a RF resource 218 or RF chain.

The embodiments described herein may be applicable to wireless communication devices in which the SIMs 204a and 204b share a common set of RF resource (particularly, the RF resource 218). Embodiments described herein may also be applicable to wireless communication devices in which each of the SIMs 204a and 204b has a separate RF resource, but activities of one of the SIMs 204a and 204b may be deactivated while the other one of the SIMs 204a and 204b is active.

The RF resource 218 may include at least one transceiver that perform transmit/receive functions for the associated SIMs 204a and 204b of the wireless communication device 200. The RF resource 218 may include separate transmit and receive circuitry, or may include a transceiver that combines transmitter and receiver functions. The RF resource 218 may be coupled to a wireless antenna 220. The RF resource 218 may also be coupled to the baseband modem processor 216.

In some embodiments, the general-purpose processor 206, the memory 214, the baseband modem processor 216, and the RF resource 218 may be included in the wireless communication device 200 as a system-on-chip. In some embodiments, the SIMs 204a and 204b and their corresponding interfaces 202a, 202b may be external to the system-on-chip. Further, various input and output devices may be coupled to components on the system-on-chip, such as interfaces or controllers. Example user input components suitable for use in the wireless communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the wireless communication device 200 to enable communication between them.

The wireless communication device 200 may include a communication management module 230. The communication management module 230 may configure the wireless communication device 200 to implement various software layers. For example, the communication management module 230 may implement a Media Access Control (MAC) layer, Radio Link Control (RLC) layer, and the like. Data packets received by the wireless communication device may be initially associated with the MAC layer. The RLC may be a disassembly entity that performs error correction through Automatic Repeat Request (ARQ), Hybrid ARQ (HARQ), and/or the like. The RLC may re-ordering the received data packets released by the MAC layer.

In some embodiments, the communication management module 230 may be implemented within the general-purpose processor 206. For example, the communication management module 230 may be implemented as a software application stored within the memory 214 and executed by the general-purpose processor 206. Accordingly, such embodiments can be implemented with minimal additional hardware costs. However, other embodiments relate to systems and processes implemented with dedicated hardware specifically configured for performing operations described herein with respect to the communication management module 230. For example, the communication management module 230 may be implemented as a separate processing component (i.e., separate from the general-purpose processor 206). The communication management module 230 may be coupled to the memory 214, the general processor 206, the baseband processor 216, and/or the RF resource 218 for performing the function described herein.

Hardware and/or software for the functions may be incorporated in the wireless communication device 200 during manufacturing, for example, as a part of a configuration of an original equipment manufacturer (OEM) of the wireless communication device 200. In further embodiments, such hardware and/or software may be added to the wireless communication device 200 post-manufacture, such as by installing one or more hardware devices and/or software applications onto the wireless communication device 200.

In some embodiments, the wireless communication device 200 may include, among other things, additional SIM cards, SIM interfaces, at least another RF resource associated with the additional SIM cards, and additional antennas for connecting to additional mobile networks.

Embodiments described herein relate to initiating a reduced re-ordering release timer associated with a first subscription of a wireless communication device for a reduced duration in response to determining that a length of a tune-away interval exceeds a threshold. Per 3GPP Specification: 25.321, if no re-ordering release timer is active currently, a re-ordering release timer may be initiated in response to determining that a data packet (e.g., a MAC-hs Protocol Data Unit (PDU)) having a sequence number (e.g., a Transmission Sequence Number (TSN) greater than an expected sequence number is received. Receiving a data packet with a sequence number greater than the expected sequence number may indicate that the wireless communication device has failed to receive at least one data packet.

Data packets having sequence numbers greater than the expected sequence number received while the re-ordering release timer is running may not be released to a disassembly entity (e.g., a RLC layer) for processing. Instead, such data packets remain with the MAC layer. In response to the re-ordering release timer expiring and that any data packets received during the re-ordering release timer has a sequence number greater than the expected sequence number, all received data packets received during the re-ordering release timer may be released to the disassembly entity (e.g., the RLC layer) for processing.

The longer the tune-away interval is, the lost data packets are less likely to be recovered through recovery retransmission processes, such as, but not limited to, Hybrid Automatic Repeat Request (HARQ) retransmissions. Thus, by initiating a reduced re-ordering release timer having a reduced length for situations in which the lost data packets are unlikely to be recovered, the wireless communication device can release the data packets received during the re-ordering release timer to the disassembly entity more quickly, thus reducing the scheduling hole.

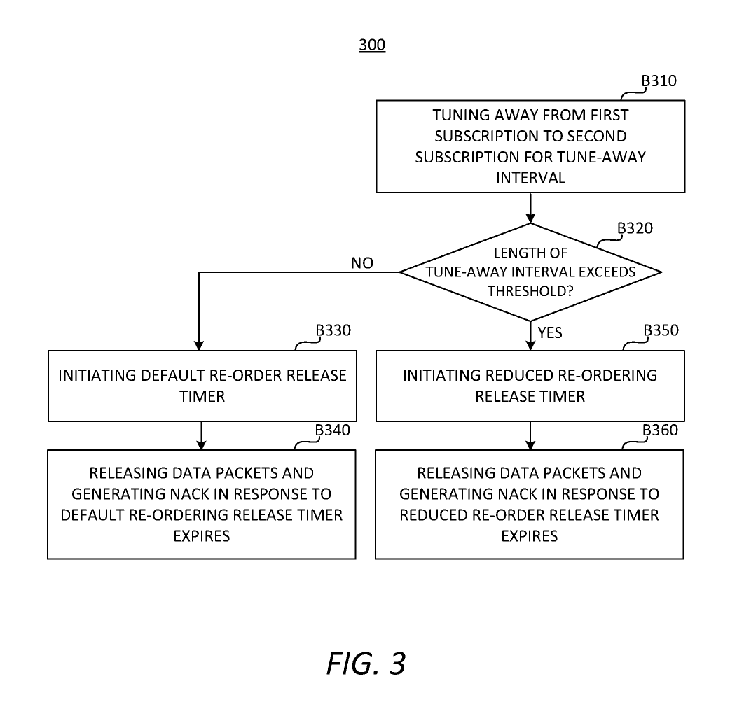

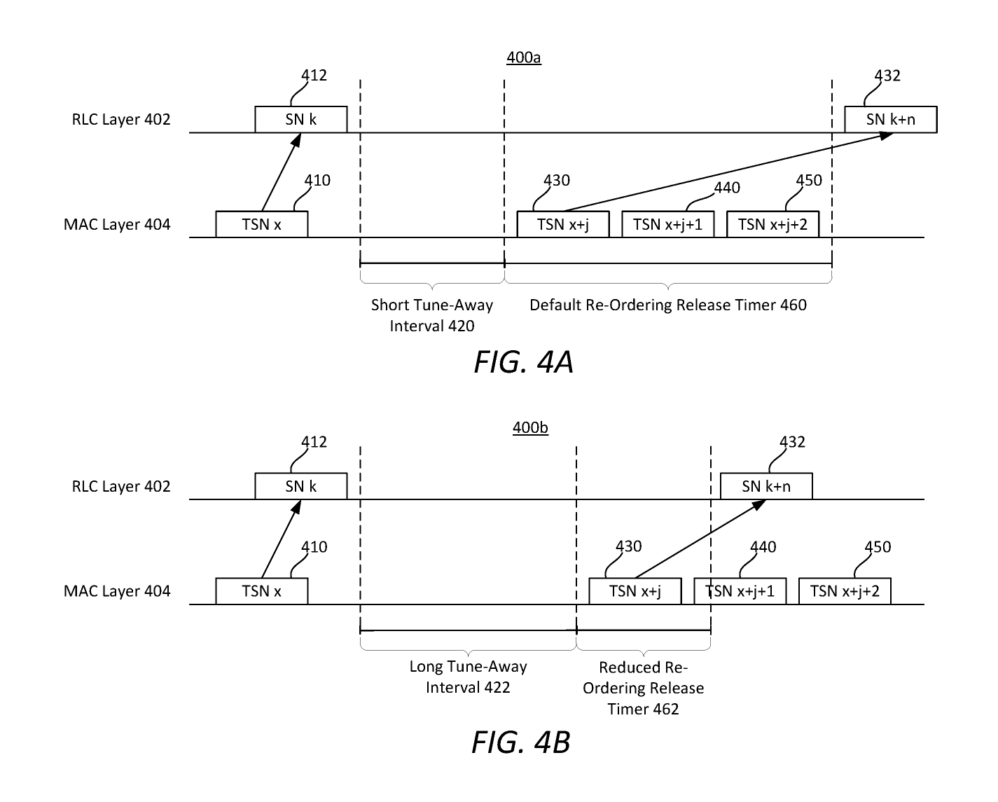

FIG. 3 is a process flowchart diagram illustrating an example of a communication management method 300 according to various embodiments. FIG. 4A is a schematic diagram 400a illustrating an example of the communication management method 300 (FIG. 3) according to some embodiments. FIG. 4B is a schematic diagram 400b illustrating an example of the communication management method 300 (FIG. 3) according to some embodiments. Referring to FIGS. 1-4B, in some embodiments, the communication management method 300 may be performed by the communication management module 230 and/or the general-purpose processor 206 of the wireless communication device 200.

The communication management module 230 and/or the general-purpose processor 206 may implement a RLC layer 402 and a MAC layer 404 for processing data packets received and/or transmitted by the wireless communication device 200. The activities shown on the diagrams 400a and 400b may be associated with the first subscription (e.g., corresponding to SIM-1 204a). The wireless communication device 200 may receive data packets 410, 430, 440, and 450 (via the RF resource 218) from the first mobile network 102. The data packets 410, 430, 440, and 450 may be received in the MAC layer 404. Each data packet may be a High Speed (HS)-PDU.

The wireless communication device 200 may receive the data packet 410 from the first mobile network 102 (e.g., from the first base station 130) associated with the first subscription prior to the tune-away interval 420 or 422. The data packet 410 may have a sequence number (e.g., TSN) of x. The MAC layer 404 may release the data packet 410 to the RLC layer 402. A data packet 412 corresponding to the data packet 410 may be released to the RLC layer 402. The data packet 412 may have a Sequence Number (SN) of k, which corresponds to the TSN x through any suitable correspondence.

At block B310, the communication management module 230 and/or the general-purpose processor 206 may tune away from the first subscription to the second subscription (e.g., corresponding to SIM-2 204b) for a tune-away interval. For example, the communication management module 230 and/or the general-purpose processor 206 may configure the RF resource 218 for activities (e.g., reception and/or transmission activities) of the second subscription. As referred to herein, a “short” tune-away interval 420 may have a length that does not exceed the threshold, and a “long” tune-away interval 422 may have a length that exceeds the threshold. Thus, the diagram 400a represents a scenario in which the short tune-away interval 420 does not exceed the threshold (B320: NO). The diagram 400b represents a scenario in which the long tune-away interval 422 exceeds the threshold (B320: YES). Activities of the first subscription may overlap in time with the usage of the second subscription during the tune-away interval (e.g., the short tune-away interval 420 or the long tune-away interval 422). For example, the wireless communication device may fail to receive at least one data packet having a TSN between x and x+j (where j>1) due to the tune-away interval. Given that the last received data packet 410 has a TSN x, the expected TSN may be x+1. If the subsequently received data packet 430 has a TSN of x+j (where j>1), the communication management module 230 and/or the general-purpose processor 206 may determine that at least one data packet is lost due to the discontinuous TSNs.

At block B320, the communication management module 230 and/or the general-purpose processor 206 may determine whether a length of the tune-away interval exceeds a threshold. The length of the tune-away interval (e.g., the long tune-away interval 422) exceeding the threshold indicates that there is a high likelihood that the missing data packet(s) (e.g., the data packet(s) having TSN(s) between x and x+j) are not recoverable through any recovery retransmission processes. Illustrating with a non-limiting example, the threshold may be 100 ms. Illustrating with other non-limiting examples, the threshold may be 80 ms, 120 ms, 140 ms, 200 ms, or the like.

The threshold for the length of the tune-away interval can be any suitable threshold set based on one or more of network or link conditions, type of RAT associated with the first subscription, geographical locations of the wireless communication device 200, or the like. Illustrating with a non-limiting example, the threshold may increase in response to determining that the network or link conditions are favorable, vice versa. In some embodiments, the threshold may be increased or decreased from a baseline threshold on a case-by-case basis based on network conditions associated with the first subscription. In some embodiments, a Block Error Rate (BLER) being above an error rate threshold or an increase in the BLER may trigger a proportional decrease based on the baseline threshold. On the other hand, the BLER being below an error rate threshold or a decrease in the BLER may trigger a proportional increase based on the baseline threshold. Other measures of network quality with respect to the first subscription may be similarly implemented to decrease the threshold if the network conditions are known to be unfavorable, adding to the likelihood of lost data packets.

In alternative or additional embodiments, the threshold may vary according to different RATs associated with the first subscription. Illustrating with another non-limiting example, the threshold may be greater for a first RAT (such as, but not limited to, LTE) as compared to that of a second RAT (such as, but not limited to, 1×). Illustrating with yet another non-limiting example, the threshold may be greater for a first geographical region than that of a second geographical region.

In response to determining that the length of the tune-away interval (e.g., the short tune-away interval 420) does not exceed the threshold (B320: NO), the communication management module 230 and/or the general-purpose processor 206 may initiate a default re-ordering release timer 460, at block B330. The default re-ordering release timer 460 may have a conventional length, as configured by the first mobile network 102 and/or specified by suitable standards. Illustrating with a non-limiting example, the default re-ordering release timer 460 may have a length of 200 ms.

During the default re-ordering release timer 460, the communication management module 230 and/or the general-purpose processor 206 may configure the MAC layer 404 to not release any of the data packets received during the default re-ordering release timer 460 to the RLC layer 402 for processing.

At block B340, the communication management module 230 and/or the general-purpose processor 206 may release the data packet 430 (with TSN x+j) to the RLC layer 402 for processing. For example, a data packet 432 with SN of k+n that corresponds to the data packet 430 may be released to the RLC layer 402 in response to the default re-ordering release timer 460 expiring. The data packets 440 (with TSN x+j+1) and 450 (with TSN x+j+2) received during the default re-ordering release timer 460 may also be released to the RLC layer 402. In some embodiments, a status report (e.g., a Negative Acknowledgement (NACK)) indicating reception failure with respect to data packets having TSN between x and x+j (where j>2) may be generated in response to the default re-ordering release timer 460 expiring.

On the other hand, in response to determining that the length of the tune-away interval (e.g., the long tune-away interval 422) exceeds the threshold (B320: YES), the communication management module 230 and/or the general-purpose processor 206 may initiate a reduced re-ordering release timer 462, at block B350. The reduced re-ordering release timer 462 may have a length shorter than that of the default re-ordering release timer 460. Illustrating with a non-limiting example, the length (L_{reduced}_{_}_{re-order}) of the reduced re-ordering release timer 462 may be determined using the following expression:

L_{reduced}_{_}_{re-order}=MAX(0,L_{default}_{_}_{re-order}−L_{tune-away}); (1)

where L_{default}_{_}_{re-order} is the length of the default re-ordering release timer 460, and, L_{tune-away} is the length of the long tune-away interval 422. Illustrating with a non-limiting example in which L_{tune-away} is 140 MS and L_{default}_{_}_{re-order} is 200 ms, the L_{reduced}_{_}_{re-order} may be 60 ms.

The expression (1) provides that the length of the reduced re-ordering release timer 462 is a non-negative number. In the event that the length of the long tune-away interval 422 is greater than the length of the default re-ordering release timer 460, the length of the reduced re-ordering release timer 462 may be set to 0. That is, the data packets 430, 440, and 450 received after the long tune-away interval 422 may be released immediately following the long tune-away interval 422 without delay once received. Similarly when the length of the reduced re-ordering release timer 462 is determined to be 0, the status report (e.g., the NACK) may be generated in response to the long tune-away interval 422 ending without delay.

During the reduced re-ordering release timer 462 (if the length of the reduced re-ordering release timer 462 is determined to be non-zero), the communication management module 230 and/or the general-purpose processor 206 may configure the MAC layer 404 to not release any of the data packets received during the reduced re-ordering release timer 462 to the RLC layer 402 for processing until expiration of the reduced re-ordering release timer 462.

At block B360, the communication management module 230 and/or the general-purpose processor 206 may release the data packet 430 (with TSN x+j) to the RLC layer 402 for processing. For example, the data packet 432 with SN of k+n that corresponds to the data packet 430 may be released to the RLC layer 402 in response to the reduced re-ordering release timer 462 expiring. The data packets 440 (with TSN x+j+1) and 450 (with TSN x+j+2) received during the reduced re-ordering release timer 462 may also be released to the RLC layer 402. In some embodiments, a status report (e.g., a Negative Acknowledgement (NACK)) indicating reception failure with respect to data packets having TSN between x and x+j (where j>2) may be generated in response to the reduced re-ordering release timer 462 expiring.

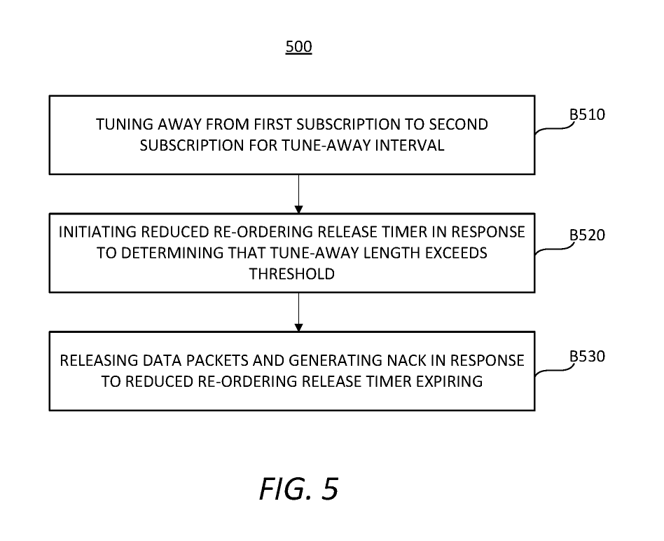

FIG. 5 is a process flowchart diagram illustrating an example of a communication management method 500 according to various embodiments. One or more of blocks B310-B360 of FIG. 3 may correspond to one of blocks B510-B530. Referring to FIGS. 1-5, in some embodiments, the communication management method 500 may be performed by the communication management module 230 and/or the general-purpose processor 206 of the wireless communication device 200 according to some embodiments.

At block B510, the communication management module 230 and/or the general-purpose processor 206 may tune away the RF resource 218 from the first subscription (associated with SIM-1 204a) to the second subscription (associated with SIM-2 204b) for a tune-away interval (e.g., the long tune-away interval 422). The length of the tune-away interval is determined.

At block B520, the communication management module 230 and/or the general-purpose processor 206 may initiate the reduced re-ordering release timer 462 in response to determining that the length of the tune-away interval exceeds the threshold.

At block B530, the communication management module 230 and/or the general-purpose processor 206 may release the data packets (such as, but not limited to, the data packets 430, 440, and 450) received after to the tune-away interval (such as, but not limited to, the long tune-away interval 422) from the MAC layer 404 to the RLC layer 402 in response to the reduced re-ordering release timer 462 expiring. The status report (e.g., the NACK corresponding to the lost data packets) may also be generated at the expiration of the reduced re-ordering release timer 462.

In an instance in which a poll bit is received before a tune-away interval and a status report (e.g., a status PDU) corresponding to the poll bit is blocked by the tune-away interval and any remaining portion of a previous status prohibit timer, the status report can only be transmitted after the tune-away and the previous status prohibit timer are both completed. When the status report is transmitted after the tune-away interval ends, a new status prohibit timer associated with the status report may be started to prohibit any additional status reports from being transmitted. Thus, the tune-away interval may delay transmission of status reports following the tune-away interval conventionally, causing a transmission window (TX_Win) of the first mobile network 102 to be full easily.

Some embodiments are directed to initiating a status prohibit timer (e.g., a reduced status prohibit timer) having a reduced length as compared to a default status prohibit timer to accelerate transmission of status reports after a tune-away from the first subscription to the second subscription. For instance, in response to determining that the tune-away interval delays the status report, the wireless communication device 200 may start the reduced status prohibit timer such that any subsequent status reports would not need to be delayed by the full length of the default status prohibit timer.

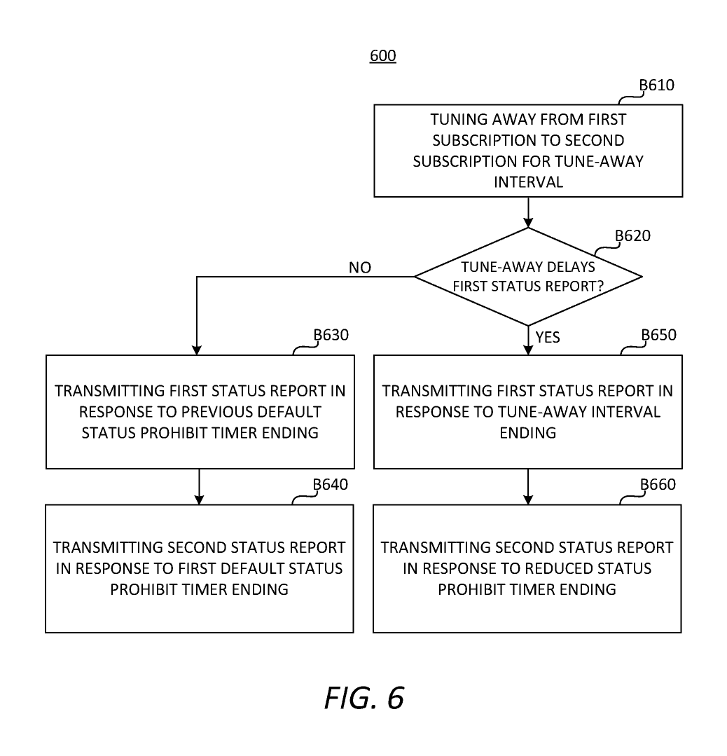

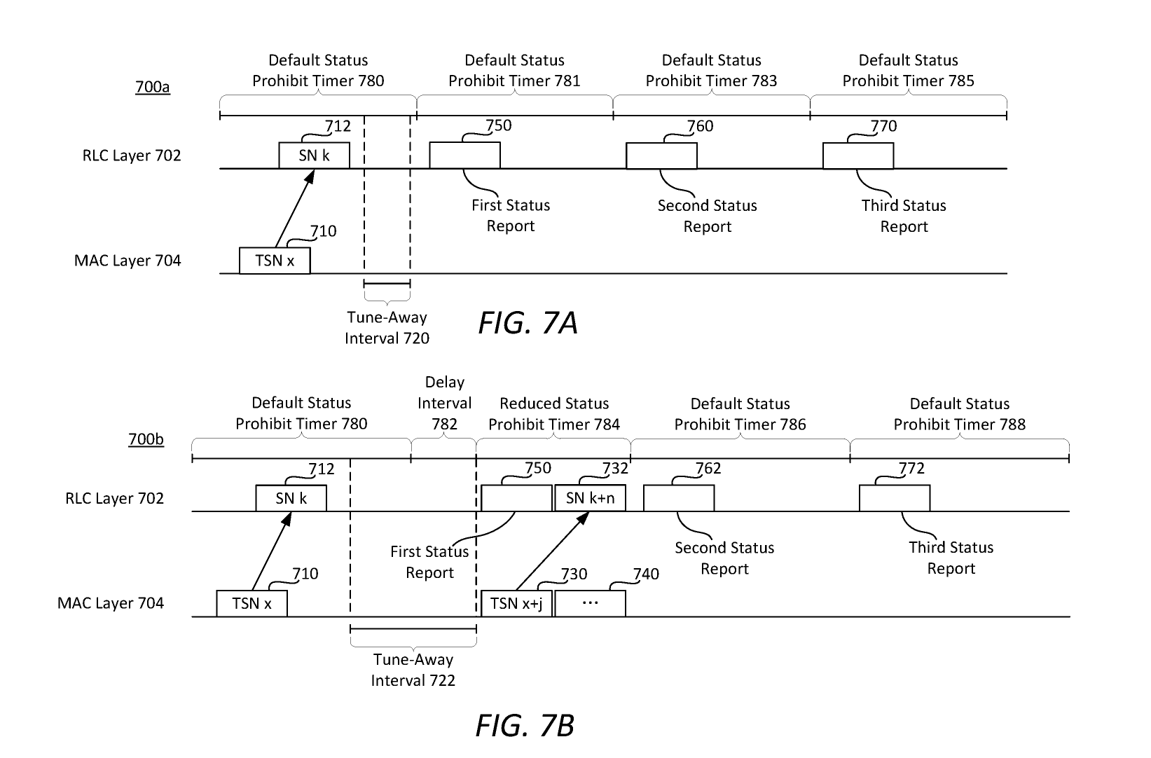

FIG. 6 is a process flowchart diagram illustrating an example of a communication management method 600 according to various embodiments. FIG. 7A is a schematic diagram 700a illustrating an example of the communication management method 600 (FIG. 6) according to some embodiments. FIG. 7B is a schematic diagram 700b illustrating an example of the communication management method 600 (FIG. 6) according to some embodiments. Referring to FIGS. 1-7B, in some embodiments, the communication management method 600 may be performed by the communication management module 230 and/or the general-purpose processor 206 of the wireless communication device 200.

The communication management module 230 and/or the general-purpose processor 206 may implement a RLC layer 702 and a MAC layer 704 for processing data packets received and/or transmitted by the wireless communication device 200. The activities shown on the diagrams 700a and 700b may be associated with the first subscription (e.g., corresponding to SIM-1 204a). The wireless communication device 200 may receive data packets 710 and 730, as well as additional data packets 740 from the first mobile network 102. The data packets 710, 730, and 740 may be received in the MAC layer 704. Each data packet may be a HS-PDU.

The wireless communication device 200 may receive the data packet 710 from the first mobile network 102 (e.g., from the first base station 130) associated with the first subscription prior to any tune-away interval. The data packet 710 may have a TSN of x. The MAC layer 704 may release the data packet 710 to the RLC layer 702. A data packet 712 corresponding to the data packet 710 may be released to the RLC layer 702. The data packet 712 may have a SN of k, which corresponds to the TSN x through any suitable correspondence. Each of default status prohibit timers 780, 781, 783, 785, 786, and 788 may have a conventional length, as configured by the first mobile network 102 and/or specified by suitable standards. A status report may be an acknowledgement status report if the status report includes one or more of a Super Fields (SUFIs) list, BITMAP, Relative List (RLIST), or ACK.

At block B610, the communication management module 230 and/or the general-purpose processor 206 may tune away from the first subscription to the second subscription for a tune-away interval (e.g., the tune-away interval 720 or 722). For example, the communication management module 230 and/or the general-purpose processor 206 may configure the RF resource 218 for activities (e.g., reception and/or transmission activities) of the second subscription.

At block B620, the communication management module 230 and/or the general-purpose processor 206 may determine whether the tune-away interval 720 or 722 delays a first status report 750. The first status report 750 may be responsive to a poll bit (e.g., the data packet 710 (712)) received before the tune-away interval 720 or 722. In some embodiments, the tune-away interval 720 or 722 delays the first status report 750 if a length of the tune-away interval 720 or 722 exceeds a threshold. Illustrating with a non-limiting example, the threshold may be 100 ms. Illustrating with other non-limiting examples, the threshold may be 80 ms, 120 ms, 140 ms, 200 ms, and/or the like. For instance, the diagram 700a pertains to the first status report 750 not being delayed by the tune-away interval 720 (B620: NO), given that the length of the tune-away interval 720 does not exceed the threshold. On the other hand, the diagram 700b pertains to the first status report 750 being delayed by the tune-away interval 722 (B620: YES), given that the length of the tune-away interval 722 exceeds the threshold.

In additional or alternative embodiments, the tune-away interval 720 or 722 delays the first status report 750 if the first status report 750 cannot be transmitted at the expiration of a default status prohibit timer 780. The default status prohibit timer 780 may be initiated prior to the tune-away interval 720 or 722. In other words, the tune-away interval 720 or 722 delays the first status report 750 if at least a portion of the tune-away interval 720 remains after the default status prohibit timer 780 expires.

Illustrating with a non-limiting example, the diagram 700a pertains to the first status report 750 not being delayed by the tune-away interval 720 (B620: NO). The tune-away interval 720 occurs entirely within the default status prohibit timer 780. As the default status prohibit timer 780 expires, the first status report 750 can be transmitted (subject to any latency not discussed for clarity) without standing by for the tune-away interval 720, as the tune-away interval 720 ended before the expiration of the default status prohibit timer 780. In other embodiments, the first status report 750 cannot be delayed by the tune-away interval 720 if the tune-away interval 720 ends at the same time as the default status prohibit timer 780. A default status prohibit timer 781 triggered by the first status report 750 may immediately follow the default status prohibit timer 780 without any time gap therebetween.

In response determining that the tune-away interval 720 does not delay the first status report 750 (B620: NO), the communication management module 230 and/or the general-purpose processor 206 may transmit the first status report 750 in response to the previous default status prohibit timer 780 ending, at block B630. Illustrating with a non-limiting example, the first status report 750 may be an ACK corresponding to successful reception of the data packet 710 (712). A first default status prohibit timer (e.g., the default status prohibit timer 781) may be triggered, for example, by the first status report 750. Thus, the first status prohibit timer 781 may be initiated in response to the previous default status prohibit timer 780 ending, at block B630.

At block B640, the communication management module 230 and/or the general-purpose processor 206 may transmit a second status report 760 in response to the first status prohibit timer 781 ending. Illustrating with a non-limiting example, the second status report 760 may be a NACK corresponding to any data packets lost during the tune-away interval 720. Lost data packets can be determined based on TSN or SN in the manner described. The default status prohibit timer 783 may be initiated in response to the second status report 760 being transmitted.

Similarly, the communication management module 230 and/or the general-purpose processor 206 may transmit a third status report 770 in response to the status prohibit timer 783 ending. Illustrating with a non-limiting example, the third status report 770 may be an ACK corresponding to any data packets successfully received before the third default status prohibit timer 785 is initiated. The third default status prohibit timer 785 may be initiated in response to the third status report 770 being transmitted.

On the other hand, the diagram 700b pertains to the first status report 750 being delayed by the tune-away interval 722 (B620: YES). A portion (e.g., a delay interval 782) of the tune-away interval 722 continues to occur after the expiration of the default status prohibit timer 780. After the default status prohibit timer 780 expires, the first status report 750 cannot yet be transmitted unless the tune-away interval 722 ends, as the tune-away interval 722 ends after the expiration of the default status prohibit timer 780.

In response determining that the tune-away interval 722 delays transmission of the first status report 750 (B620: YES), the communication management module 230 and/or the general-purpose processor 206 may transmit the first status report 750 in response to the tune-away interval 722 ending, at block B650. Illustrating with a non-limiting example, the first status report 750 may be an ACK corresponding to successful reception of the data packet 710 or 712. A reduced status prohibit timer 784 may be triggered, for example, by the first status report 750. Thus, the reduced status prohibit timer 784 may be initiated in response to the tune-away interval 722 ending, at block B650.

The reduced status prohibit timer 784 may have a length shorter than that of any of the default status prohibit timers 780, 781, 783, 785, 786, and 788. Illustrating with a non-limiting example, the length (L_{reduced}_{_}ₛₜₐₜᵤₛ) of the reduced status prohibit timer 784 may be determined based on the following expression:

L_{reduced}_{_}ₛₜₐₜᵤₛ=MAX(0,L_{default}_{_}ₛₜₐₜᵤₛ−L_{delay}); (2)

where L_{default}_{_}ₛₜₐₜᵤₛ is the length of any of the default status prohibit timers 780, 781, 783, 785, 786, and 788, and L_{delay} is the length of the delay interval 782. The L_{delay} may correspond to a remainder of the tune-away interval 722 that is between the expiration of the default status prohibit timer 780 and the end of the tune-away interval 722. Illustrating with a non-limiting example in which L_{delay} is 120 ms and L_{default}_{_}ₛₜₐₜᵤₛ is 200 ms, the L_{reduced}_{_}ₛₜₐₜᵤₛ may be 80 ms.

The expression (2) provides that the length of the reduced status prohibit timer 784 is a non-negative number. In the event that the length of the delay interval 782 is greater than the length of the default status prohibit timer 780, 781, 783, 785, 786, or 788, the length of the reduced status prohibit timer 784 may be set to 0. That is, the first status report 750 may be transmitted in response to the tune-away interval 722 or the delay interval 782 ending, and the second status report 762 may be transmitted without any additional restriction given that the length of the reduced status prohibit timer 784 is 0.

The data packets 730 and additional data packets 740 may be received in the MAC layer 704. The communication management module 230 and/or the general-purpose processor 206 may release a data packet 732 (having SN k+n) corresponding to the data packet 730 (having TSN x+j) to the RLC layer 702 after sending the first status report 750. The communication management module 230 and/or the general-purpose processor 206 may release one or more of the additional data packets 740 in a similar manner.

At block B660, the communication management module 230 and/or the general-purpose processor 206 may transmit a second status report 762 in response to the reduced status prohibit timer 784 ending. The second status report 762 may trigger the default status prohibit timer 786. Illustrating with a non-limiting example, the second status report 760 may be a NACK corresponding to any data packets lost during the tune-away interval 722. The first mobile network 102 receiving the second status report 760 earlier can cause the first mobile network 102 to retransmit the lost data packets sooner. The communication management module 230 and/or the general-purpose processor 206 may initiate the default status prohibit timer 786 in response to transmitting the second status report 762.

Similarly, the communication management module 230 and/or the general-purpose processor 206 transmit a third status report 772 in response to the default status prohibit timer 786 ending, and initiate the third default status prohibit timer 788 triggered by the third status report 772. Illustrating with a non-limiting example, the third status report 772 may be an ACK corresponding to any data packets successfully received before the default status prohibit timer 788 is initiated.

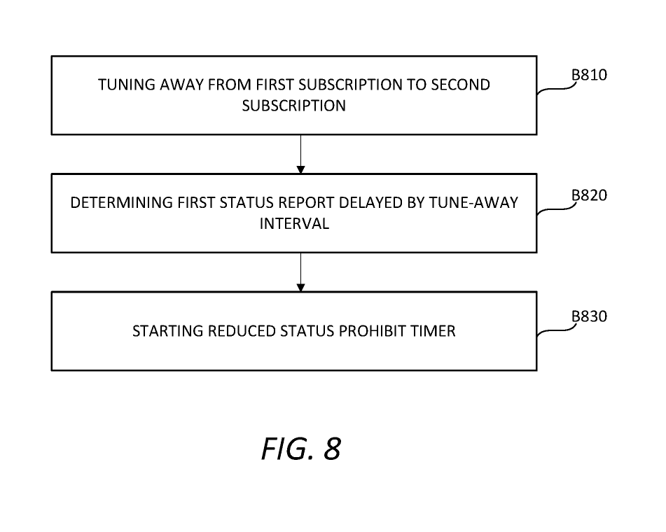

FIG. 8 is a process flowchart diagram illustrating an example of a communication management method 800 according to various embodiments. One or more of blocks B610-B660 of FIG. 6 may correspond to one of blocks B810-B830. Referring to FIGS. 1-8, in some embodiments, the communication management method 800 may be performed by the communication management module 230 and/or the general-purpose processor 206 of the wireless communication device 200 according to some embodiments.

At block B810, the communication management module 230 and/or the general-purpose processor 206 may tune away the RF resource 218 from the first subscription (associated with SIM-1 204a) to the second subscription (associated with SIM-2 204b) for a tune-away interval (e.g., the tune-away interval 720 or 722). The length of the tune-away interval 720 or 722 is determined.

At block B820, the communication management module 230 and/or the general-purpose processor 206 may determine whether the first status report 750 is delayed by the tune-away interval. In some embodiments, the tune-away interval delays the first status report 750 if a length of the tune-away interval exceeds a threshold. In additional or alternative embodiments, the tune-away interval delays the first status report 750 if the first status report 750 cannot be transmitted at the expiration of the previous default status prohibit timer 780.

At block B830, the communication management module 230 and/or the general-purpose processor 206 may start the reduced status prohibit timer 784 in response to determining that the first status report 750 is delayed by the tune-away interval (e.g., the tune-away interval 722).

Some embodiments described herein relate to reducing the transmission window (TX_Win) occupancy for the first mobile network 102 according to some embodiments. Given that tune-away intervals from the first subscription to the second subscription may cause failure to receive a considerable amount of data packets, the wireless communication device 200 may not be able to timely transmit status reports (e.g., NACKs) corresponding to the missing data packets to provide notice to the first mobile network 102. In addition, the wireless communication device 200 may not be able to timely transmit status reports (e.g., ACKs) corresponding to successfully received retransmissions of the missing data packets to inform the first mobile network 102 that the retransmissions have been received. The transmission window of the first mobile network 102 may become full if the status reports cannot be timely updated to the first mobile network 102.

To address such issues, the wireless communication device 200 may transmit a status report irrespective of the status prohibit timer in response to determining that the transmission window occupancy exceeds a threshold, increasing a number of status reports being sent, thus relieving transmission window congestion at the first mobile network 102. Once the transmission window is no longer congested (e.g., the transmission window occupancy does not reach the threshold), the wireless communication device 200 may transmit the status reports according to conventional configurations.

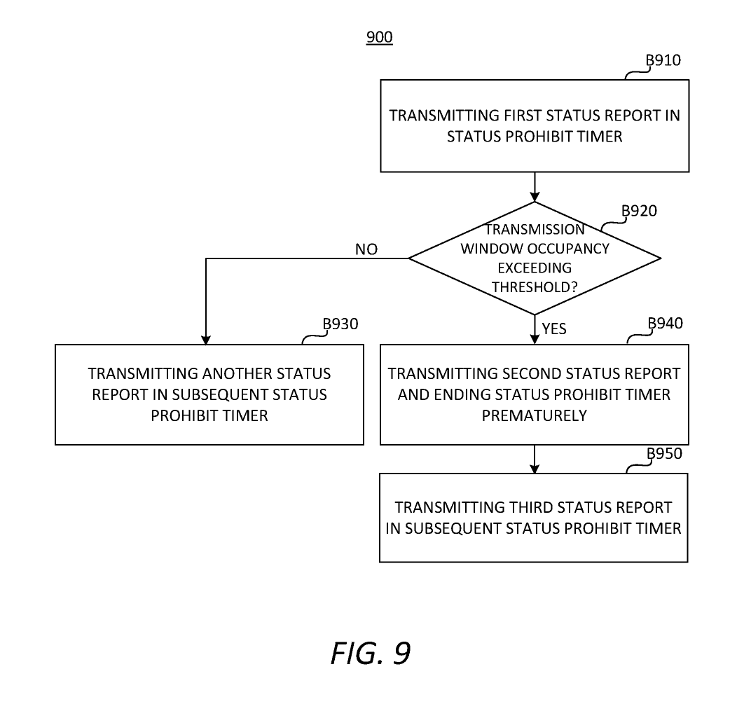

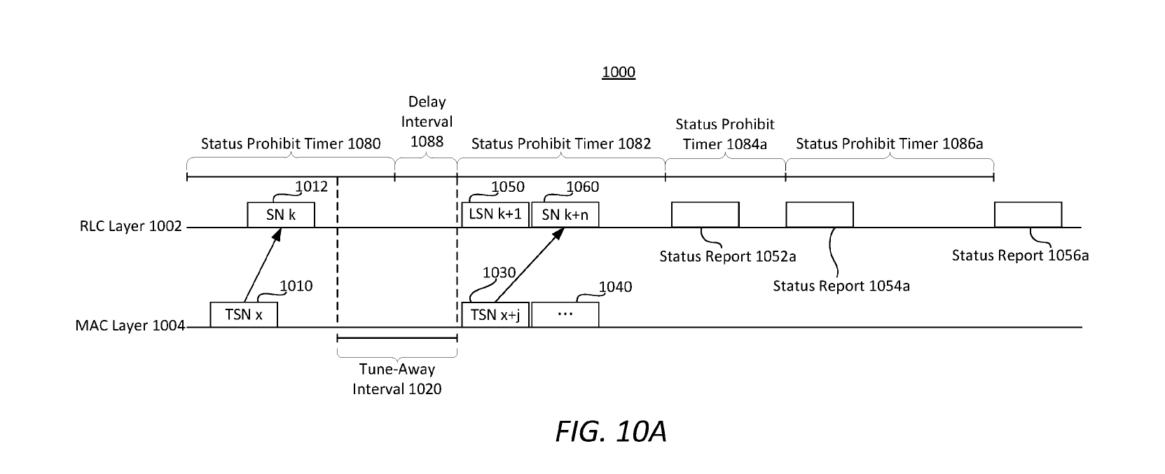

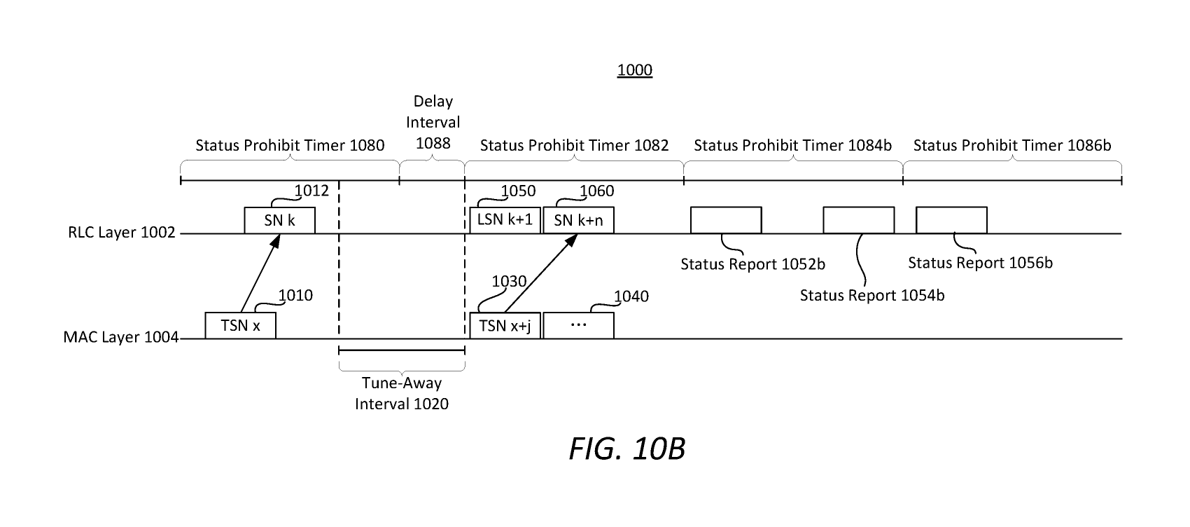

FIG. 9 is a process flowchart diagram illustrating an example of a communication management method 900 according to various embodiments. FIG. 10A is a schematic diagram 1000a illustrating an example of the communication management method 900 (FIG. 9) according to some embodiments. Referring to FIGS. 1-10A, in some embodiments, the communication management method 900 may be performed by the communication management module 230 and/or the general-purpose processor 206 of the wireless communication device 200.

The communication management module 230 and/or the general-purpose processor 206 may implement a RLC layer 1002 and a MAC layer 1004 for processing data packets received and/or to be transmitted by the wireless communication device 200. The activities shown in the diagram 1000 may be associated with the first subscription (e.g., corresponding to SIM-1 204a). The wireless communication device 200 may receive data packets 1010 and 1030, as well as additional data packets 1040 from the first mobile network 102. The data packets 1010, 1030, and 1040 may be received in the MAC layer 1004. Each data packet may be a HS-PDU.

The wireless communication device 200 may receive the data packet 1010 from the first mobile network 102 (e.g., from the first base station 130) associated with the first subscription prior to a tune-away interval 1020. The data packet 1010 may have a TSN of x. The MAC layer 1004 may release the data packet 1010 to the RLC layer 1002. A data packet 1012 corresponding to the data packet 1010 may be released to the RLC layer 1002. The data packet 1012 may have a SN of k, which corresponds to the TSN x through any suitable correspondence. Each of status prohibit timers 1080, 1082, 1086a may have a conventional length (e.g., length of the default status prohibit timers 780, 781, 783, 785, 786, 788), as configured by the first mobile network 102 and/or specified by suitable standards. In some embodiments, the status prohibit timer 1082 may have a reduced length such as, but not limited to, the length of the reduced status prohibit timer 784. In some embodiments, the status prohibit timer 1084a may be shortened so that the status report 1054a can be sent in response to determining the transmission window occupancy exceeding the threshold.

The tune-away interval 1020 may cause failure to receive data packets (e.g., at least one data packet with TSN between x and x+j, where j>1) associated with the first subscription. A previous status report 1050 may be delayed by a portion (e.g., a delay interval 1088) of the tune-away interval 1020 in some embodiments. The previous status report 1050 may correspond to successful reception of the data packet 1010 (1012) or another packet successful received before the tune-away interval 1020. Illustrating with a non-limiting example, the previous status report 1050 may be an ACK with a Last SN (LSN) of k+1. The LSN of the previous status report 1050 may be referred to as a previous sequence number.

The previous status report 1050 may trigger the status prohibit timer 1082 to be initiated. The data packet 1030 received after the tune-away interval 1020 may have a TSN of x+j, where j>1. The data packet 1030 may be released to the RLC layer 1002 as a data packet 1060 with a SN of k+n, where n>2. The communication management module 230 and/or the general-purpose processor 206 may detect the discontinuous SN or TSN and generate a NACK (e.g., the status report 1052a) as the RLC layer 1002 receives the released data packet 1060 from the MAC layer 1004. In some embodiments, the first status report 1052a cannot be transmitted before the expiration of the status prohibit timer 1082, give that at that time, the transmission window occupancy may not exceed the threshold.

At block B910, the communication management module 230 and/or the general-purpose processor 206 may transmit the status report 1052a corresponding to the status prohibit timer 1084a. The status prohibit timer 1084a may be triggered by the transmission of the first status report 1052a. The first status report 1052a may be generated prior to transmission, for example, in response to determining the discontinuous SN or TSN. Illustrating with a non-limiting example, the status report 1052a may be the NACK corresponding to the discontinuous SN associated with the data packet 1060.

At block B920, the communication management module 230 and/or the general-purpose processor 206 may determine whether the transmission window occupancy (TX_Win occupancy) on the network side of the first mobile network 102 exceeds a threshold. The transmission window occupancy is a network-side parameter. However, the communication management module 230 and/or the general-purpose processor 206 may determine the transmission window occupancy using the following expression:

$$\frac{vr\_r - {LSN}_{p}}{{RX\_Win}_{total}} \qquad ( 3 )$$

where vr_r (also commonly known as “VR(R)”) may be a receive state variable containing a SN following the SN of the last in-sequence Acknowledged Mode Data (AMD) PDU received from the first mobile network 102. In other words, vr_r equals the SN of the last in-sequence AMD PDU received, plus one. In some instances, vr_r can be updated (increased by 1) upon receiving an AMD PDU with SN equal to vr_r. In some embodiments, vr_r can be viewed as a lower edge of a receiving window (e.g., RX_WIN).

LSNₚ is the previous sequence number (e.g., LSN k+1) of the previous status report 1050 transmitted to the first mobile network 102. The previous status report 1050 may be the most recent status report sent to the first mobile network 102 before the first status report 1052a. There may not be any status reports between the previous status report 1050 and the first status report 1052a. LSNₚ acknowledges successful reception of all AMD PDUs with SN less than LSNₚ. In some embodiments, LSNₚ may represent an upper edge of the receiving window.

RX_Winₜₒₜₐₗ may refer to a total reception window, which is a parameter stored (in the memory 214) and known to the wireless communication device 200. By default configuration with the first mobile network 102, the total reception window may be the same as to the total transmission window (TX_Winₜₒₜₐₗ), which is a network-side parameter.

Thus, based on expression (3), the current transmission window occupancy may be determined based on wireless communication device-side parameters, even though the wireless communication device 200 may not have direct access to the current transmission window occupancy.

In some embodiments, the communication management module 230 and/or the general-purpose processor 206 may be configured to periodically determine whether the transmission window occupancy is above the threshold, for example, every 500 ms, 1 s, 5 s, 10 s, 20 s, or the like. In other embodiments, the communication management module 230 and/or the general-purpose processor 206 may be configured to determine whether the transmission window occupancy is above the threshold every 1, 2, 5, 10, 20, or 50 status reports generated.

The threshold for the transmission window occupancy can be any suitable threshold set based on one or more of network or link conditions, type of RAT associated with the first subscription, geographical locations of the wireless communication device 200, or the like. Illustrating with a non-limiting example, the threshold may increase in response to determining that the network or link conditions are favorable, vice versa. Illustrating with another non-limiting example, the threshold may be greater for a first RAT (such as, but not limited to, LTE) as compared to that of a second RAT (such as, but not limited to, 1×). Illustrating with yet another non-limiting example, the threshold may be greater for a first geographical region than that of a second geographical region.

In response to determining that the transmission window occupancy does not exceed the threshold (B920: NO), the communication management module 230 and/or the general-purpose processor 206 may transmit another status report in a subsequent status prohibit timer, at block B930. That is, the another status report is transmitted when the status prohibit timer 1084a expires.

On the other hand, in response to determining that the transmission window occupancy exceeds the threshold (B920: YES), the communication management module 230 and/or the general-purpose processor 206 may transmit a second status report (e.g., the status report 1054a), and ending the status prohibit timer 1084a prematurely (before the default length expires), at block B940. Thus, the second status report (e.g., the status report 1054a) may be transmitted irrespective to the fact that the status prohibit timer 1084a has yet to be expired. Accordingly, the status prohibit timer 1084a may have a shortened length. The second status report may be generated prior to transmission responsive to any data packets (e.g., the data packet 1030) successfully received or any data packets missed. A subsequent status prohibit timer 1086a may be initiated with a default length in response to sending the second status report.

At block B950, the communication management module 230 and/or the general-purpose processor 206 may transmit a third status report (e.g., the status report 1056a) in a subsequent status prohibit timer (after the expiration of the status prohibit timer 1086a). The subsequent status prohibit timer may be initiated in response to transmitting the status report 1056a. The third status report may be generated prior to transmission responsive to any data packets (e.g., one or more of the data packet 1040) successfully received or any data packets missed.

Though the embodiments are described with reference to the tune-away interval 1020 for disclosing one of the causes of the transmission window occupancy being full, it is important to note that the method 900 does not require the tune-away interval 1020 to occur or to occur in the exact nature as set forth in diagram 1000. As long as the communication management module 230 and/or the general-purpose processor 206 determines that the transmission window occupancy is above the threshold (B920: YES), the communication management module 230 and/or the general-purpose processor 206 can configure the RF resource 218 to transmit another status report (e.g., the second status report, such as, but not limited to, the status report 1054a) irrespective of whether the previous status prohibit timer has expired.

FIG. 10B is a schematic diagram 1000b illustrating an example of the communication management method 900 (FIG. 9) according to some embodiments. Referring to FIGS. 1-10B, the diagram 1000b may be an alternative embodiment to the diagram 1000a. For instance, instead of ending the status prohibit timer 1084a prematurely (at B940), the communication management module 230 and/or the general-purpose processor 206 may transmit a second status report (e.g., a status report 1054b) in the same status prohibit timer (e.g., the status prohibit timer 1084b) in response to determining that the transmission window occupancy exceeds the threshold (B920: YES). Thus, the second status report (e.g., the status report 1054b) may be transmitted irrespective to the fact that the status prohibit timer 1084b (started in response to the status report 1052b) has yet expired. The second status report may be generated prior to transmission responsive to any data packets (e.g., the data packet 1030) successfully received or any data packets missed.

Subsequently, the communication management module 230 and/or the general-purpose processor 206 may transmit a third status report (e.g., the status report 1056b) in a subsequent status prohibit timer (e.g., the status prohibit timer 1086b). The status prohibit timer 1086b may be initiated in response to transmitting the status report 1056b. The third status report may be generated prior to transmission responsive to any data packets (e.g., one or more of the data packet 1040) successfully received or any data packets missed.

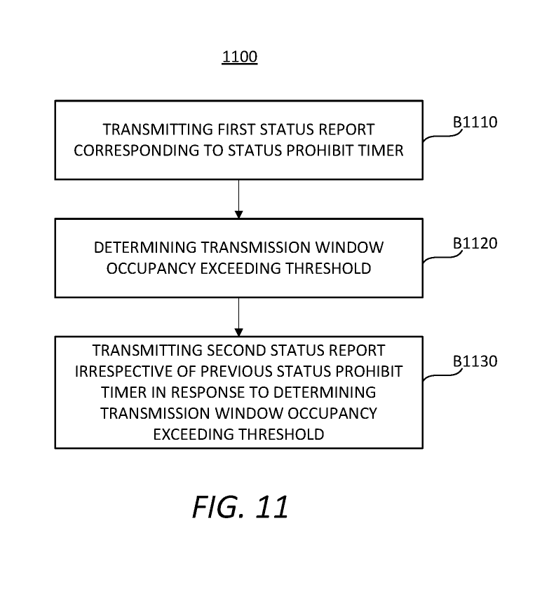

FIG. 11 is a process flowchart diagram illustrating an example of a communication management method 1100 according to various embodiments. One or more of blocks B910-B950 of FIG. 9 may correspond to one of blocks B1110-B1130. Referring to FIGS. 1-11, in some embodiments, the communication management method 1100 may be performed by the communication management module 230 and/or the general-purpose processor 206 of the wireless communication device 200 according to some embodiments.

At block B1110, the communication management module 230 and/or the general-purpose processor 206 may configure the RF resource 218 to transmit the first status report (e.g., the status report 1052a) corresponding to the status prohibit timer (e.g., the status prohibit timer 1084a) in some embodiments. The status prohibit timer may be initiated in response to transmitting the first status report.

At block B1120, the communication management module 230 and/or the general-purpose processor 206 may determine that the transmission window occupancy exceeds the threshold in some embodiments. The transmission window occupancy can be determined based on the expression (3).

At block B1130, the communication management module 230 and/or the general-purpose processor 206 may configure the RF resource 218 to transmit the second status report irrespective of previous status prohibit timer in response to determining that the transmission window occupancy exceeds the threshold. The previous status prohibit timer may have a shortened length.

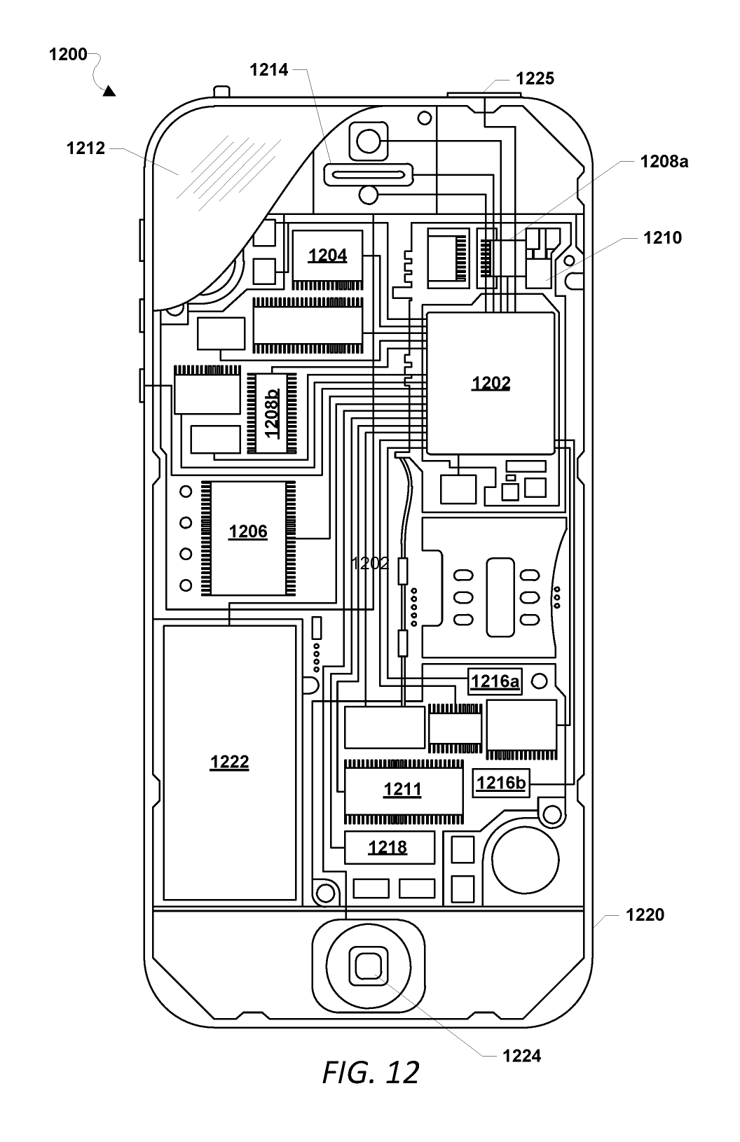

The various embodiments may be implemented in any of a variety of wireless communication devices 110 and 200, an example of which is illustrated in FIG. 12, as wireless communication device 1200. As such, the wireless communication device 1200 may implement the process and/or the apparatus of FIGS. 1-11, as described herein.

With reference to FIGS. 1-12, the wireless communication device 1200 may include a processor 1202 coupled to a touchscreen controller 1204 and an internal memory 1206. The processor 1202 may be one or more multi-core integrated circuits designated for general or specific processing tasks. The memory 1206 may be volatile or non-volatile memory, and may also be secure and/or encrypted memory, or unsecure and/or unencrypted memory, or any combination thereof. The touchscreen controller 1204 and the processor 1202 may also be coupled to a touchscreen panel 1212, such as a resistive-sensing touchscreen, capacitive-sensing touchscreen, infrared sensing touchscreen, etc. Additionally, the display of the wireless communication device 1200 need not have touch screen capability.

The wireless communication device 1200 may have one or more cellular network transceivers 1208a, 1208b coupled to the processor 1202 and to at least one antenna 1210 and configured for sending and receiving cellular communications. The transceivers 1208a, 1208b and antenna 1210 may be used with the above-mentioned circuitry to implement the various embodiment methods. The cellular network transceivers 1208a, 1208b may be the RF resource 218. The antenna 1210 may be the antenna 220. The wireless communication device 1200 may include two or more SIM cards 1216a, 1216b, corresponding to SIM-1 204a (the first SIM) and SIM-2 204b (the second SIM), coupled to the transceivers 1208a, 1208b and/or the processor 1202. The wireless communication device 1200 may include a cellular network wireless modem chip 1211 (e.g., the baseband modem processor 216) that enables communication via at least one cellular network and is coupled to the processor 1202.

The wireless communication device 1200 may include a peripheral device connection interface 1218 coupled to the processor 1202. The peripheral device connection interface 1218 may be singularly configured to accept one type of connection, or multiply configured to accept various types of physical and communication connections, common or proprietary, such as USB, FireWire, Thunderbolt, or PCIe. The peripheral device connection interface 1218 may also be coupled to a similarly configured peripheral device connection port (not shown).

The wireless communication device 1200 may also include speakers 1214 for providing audio outputs. The wireless communication device 1200 may also include a housing 1220, constructed of a plastic, metal, or a combination of materials, for containing all or some of the components discussed herein. The wireless communication device 1200 may include a power source 1222 coupled to the processor 1202, such as a disposable or rechargeable battery. The rechargeable battery may also be coupled to a peripheral device connection port (not shown) to receive a charging current from a source external to the wireless communication device 1200. The wireless communication device 1200 may also include a physical button 1224 for receiving user inputs. The wireless communication device 1200 may also include a power button 1226 for turning the wireless communication device 1200 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the spirit or scope of the embodiments. Thus, the present embodiments are not intended to be limited to the embodiments shown herein but is to be accorded the widest scope consistent with the following claims and the principles and novel features disclosed herein.

What is claimed is:

1. A method for a wireless communication device having a first Subscriber Identity Module (SIM) associated with a first subscription and a second SIM associated with a second subscription to manage communications over the first subscription and the second subscription, the method comprising:
tuning away from the first subscription to the second subscription for a tune-away interval;
initiating a reduced re-ordering release timer in response to determining that a length of the tune-away interval exceeds a threshold; and
generating a status report in response to the reduced re-ordering release timer expiring.

2. The method of claim 1, wherein:
a length of the reduced re-ordering release timer is shorter than a length of a default re-ordering release timer; and
the length of the default re-ordering release timer is a value configured by a network associated with the first subscription.

3. The method of claim 1, wherein a length of the reduced re-ordering release timer equals a length of a default re-ordering release timer minus a length of the tune-away interval.

4. The method of claim 1, further comprising releasing data packets received during the reduced re-ordering release timer from a Media Access Control (MAC) layer to a Radio Link Control (RLC) layer for processing in response to the reduced re-ordering release timer expiring.

5. The method of claim 1, wherein the status report indicates that at least one data packet of the first subscription is lost due to the tune-away interval.

6. The method of claim 5, further comprising determining whether the at least one data packet of the first subscription is lost based on a first sequence number associated with a data packet received before the tune-away interval and a second sequence number associated with another data packet received after the tune-away interval.

7. The method of claim 1, wherein the status report is a Negative Acknowledgement (NACK) Protocol Data Unit (PDU).

8. The method of claim 1, further comprising determining whether the length of the tune-away interval exceeds the threshold.

9. The method of claim 1, further comprising initiating a default re-ordering release timer in response to determining that the length of the tune-away interval fails to exceed the threshold.

10. The method of claim 9, further comprising:
generating another status report in response to the default re-ordering release timer expiring; and
releasing at least one data packet received during the default re-ordering release timer from a Media Access Control (MAC) layer to a Radio Link Control (RLC) layer for processing in response to the default re-ordering release timer expiring

11. A wireless communication device, comprising:
at least one radio frequency (RF) resource;
a processor configured to connect to a first Subscriber Identity Module (SIM) associated with a first subscription and to a second SIM associated with a second subscription, and configured to:
tune away from the first subscription to the second subscription for a tune-away interval;
stand by for a reduced re-ordering release timer in response to determining that a length of the tune-away interval exceeds a threshold; and
perform one or more of:
generating a status report in response to the reduced re-ordering release timer expiring; or
delivering data packets received during the reduced re-ordering release timer from a Media Access Control (MAC) layer to a Radio Link Control (RLC) layer for processing in response to the reduced re-ordering release timer expiring; and
a memory.

12. A method for a wireless communication device having a first Subscriber Identity Module (SIM) associated with a first subscription and a second SIM associated with a second subscription to manage communications over the first subscription and the second subscription, the method comprising:
tuning away from the first subscription to the second subscription for a tune-away interval;
determining that a first status report associated with the first subscription has been delayed by the tune-away interval; and
starting a reduced status prohibit timer in response to the tune-away interval expiring.

13. The method of claim 12, further comprising sending the first status report in response to the tune-away interval ending.

14. The method of claim 12, wherein the first status report is determined to be delayed by the tune-away interval in response to determining that a length of the tune-away interval exceeds a threshold.

15. The method of claim 12, wherein:
a length of the reduced status prohibit timer is shorter than a length of a default status prohibit timer; and
the length of the default status prohibit timer is a value configured by a network associated with the first subscription.

16. The method of claim 12, wherein:
a length of the reduced status prohibit timer equals a length of a default status prohibit timer minus a delay interval; and
the delay interval is a time interval between an end of a previous status prohibit timer and an end of the tune-away interval.

17. The method of claim 12, further comprising initiating a default status prohibit timer in response to the reduced status prohibit timer expiring.

18. The method of claim 12, further comprising sending a second status report in response to the reduced status prohibit timer expiring.

19. The method of claim 18, wherein the second status report is a Negative Acknowledgement (NACK) Protocol Data Unit (PDU).

20. The method of claim 12, further comprising:
determining that the first status report associated with the first subscription has not been delayed by the tune-away interval; and
starting a default status prohibit timer in response a previous default status prohibit timer expiring.

21. A method for a wireless communication device having a first Subscriber Identity Module (SIM) associated with a first subscription and a second SIM associated with a second subscription to manage communications over the first subscription and the second subscription, the method comprising:
transmitting a first status report corresponding to a status prohibit timer;
determining that a transmission window occupancy exceeds a threshold; and
transmitting a second status report irrespective of the status prohibit timer in response to determining that the transmission window occupancy exceeds the threshold.

22. The method of claim 21, wherein the threshold is 60%.

23. The method of claim 21, further comprising determining the transmission window occupancy by:
determining a difference of a state variable indicating a sequence number of a last in-sequence Acknowledged Mode Data (AMD) Protocol Data Unit (PDU) received from a mobile network associated with the first subscription and a previous sequence number associated with a previous status report transmitted to the network; and
dividing the difference by a total reception window.

24. The method of claim 23, wherein the previous sequence number is a Last Sequence Number (LSN).

25. The method of claim 23, wherein:
the total reception window is associated with the wireless communication device; and
the transmission window occupancy is associated with a network of the first subscription.

26. The method of claim 23, wherein the total reception window equals to a total transmission window of a network associated with the first subscription.

27. The method of claim 21, further comprising starting a subsequent status prohibit timer in response to transmitting the second status report.

28. The method of claim 21, wherein a length of the status prohibit timer is shortened by transmission of the second status report.

29. The method of claim 21, further comprising tuning away from the first subscription to the second subscription during a tune-away interval, wherein the wireless communication device fails to receive at least one data packet associated with the first subscription during the tune-away interval.

30. The method of claim 21, wherein the first status report is a Negative Acknowledgement (NACK) Protocol Data Unit (PDU) corresponding to at least one data packet failed to be received by the wireless communication device.
